(19) United States
(12) Patent Application Publication
(10) Pub. No.: US 2025/0154433 A1
(43) Pub. Date: May 15, 2025

(54) Cleaner for Hard Surfaces

(71) Applicant: Locus Solutions IPCo, LLC, Solon, OH (US)

(72) Inventors: Ayenda ZEMAITIS, Midlothian, VA (US); Andrew MORRIS, Richmond, VA (US); Daniel HAGAMAN, Mechanicsville, VA (US); Lee SPEIGHT, Solon, OH (US)

(21) Appl. No.: 18/839,484

(22) PCT Filed: Jul. 12, 2023
(86) PCT No.: PCT/US2023/070034

§ 371 Date: Aug. 19, 2024

Related U.S. Application Data
(60) Provisional application No. 63/389,144, filed on Jul. 14, 2022.

(51) Int. Cl. C11D 1/40; B08B 3/02; C11D 3/22; C11D 3/43

(52) U.S. Cl. CPC C11D 1/40; B08B 3/026; C11D 3/22; C11D 3/43; C11D 2111/14

(57) ABSTRACT

The subject invention provides biosurfactants, as well as their use to, for example, efficiently clean contaminating and/or fouling substances such as paint, mold and algae from porous surfaces, and/or to enhance the cleaning of contaminants from non-porous surfaces.

### CROSS-REFERENCE TO RELATED APPLICATION

This application claims priority to U.S. Provisional Patent Application No. 63/389,144, filed Jul. 14, 2022, which is incorporated herein by reference in its entirety.

### BACKGROUND

Graffiti is the unauthorized spraying of paint or the application of chalk, dye, permanent inks or any other substance, to mark buildings, fences, buses, trains, road signs, bridges or similar places or surfaces. Removing graffiti is difficult because of the great variety of marking materials, many of which are inherently difficult to remove, as well as the many types of surfaces on which they are applied. These surfaces include acrylic, aluminum, brick, ceramics, concrete, glass, metals, stainless steel, masonry, block, stone, aggregate panels, asphalt surfaces, non-laminated wood, painted surfaces, and some plastics. Of particular difficulty to clean are porous surfaces, such as untreated wood, concrete, stone and brick, given that the markings can penetrate deep into the surface pores.

The general methods for dealing with graffiti include removal by chemical treatments, laser removal, an abrasive method such as sandblasting, or repainting over the graffiti. Each method has disadvantages in terms of cost, labor and environmental impact.

Chemical graffiti removal traditionally comprises applying a cleaning agent, typically comprising a diluted solvent, onto the surface to be cleaned; waiting for the agent to dissolve the graffiti, and optionally brushing or rubbing the agent onto the surface to improve the cleaning effect; and high-pressure washing with hot water. The cleaning compositions usually contain a relatively non water-soluble solvent, as well as emulsifiers and/or surfactants for formulation. Many of these components are considered carcinogenic and/or polluting (e.g., surfactants such as sodium lauryl sulfate and sodium octyl sulfate, and solvents such as cyclohexanone), in addition to exhibiting poor penetration of defaced porous surfaces.

Both the cleaning agent and the paint residues pose a threat to the environment as well as to the operator performing the graffiti removal. For example, the heat of the water increases the evaporation and fume formation of the cleaning agent, and the cleaning agent/hot water mixture together with the removed paint is normally left in the environment. The dilution of cleaning agents is thus common but results in a poor overall cleaning effect. Furthermore, the cleaning agent must typically remain on the surface for extended periods of time to be effective, and is typically highly specialized for the purpose, and therefore expensive.

The use of high-pressure water jets to remove graffiti may also severely damage the surface to be cleaned; this is particularly true when hot water is combined with an abrasive substance, creating a sand-blasting effect. Such substances are often employed to remove particularly difficult graffiti. Further, a high-pressure jet applied to the contaminated surface may even push the graffiti deeper into the surface pores, and thus work against its own purpose. Moreover, traditional graffiti removal equipment is large, complicated, heavy, and consumes a large amount of cleaning agent, water and energy for heating and pressurizing.

Repainting or recoating a surface is perhaps the least effective and least economical method of remediating graffiti. It requires using a paint that can cover up and mask the graffiti without the graffiti showing through. Often several coats of paint are required and result in a finish different from the original finish of the surface.

The problems faced during removal of graffiti from surfaces, particularly porous surfaces, are an ever-present challenge for businesses and government entities seeking to remediate defaced and damaged property; however, these problems are not not only confined to graffiti. For example, the cleaning of other hard porous surfaces, such as wood, concrete, siding or plaster, that have been stained with algae or mold, often requires similar high pressure, solvent-based treatments. Additionally, the contamination of porous stone surfaces with pathogens and food particles in homes and kitchens is an important safety concern.

Seals and coatings can be useful for blocking the surface pores and preventing the encroachment of contaminants and fluids. However, in instances where a seal or coating is not practical, or where the seal or coating has failed, methods for cleaning these porous surfaces are needed to restore the underlying surface.

Increasingly, consumers are looking for cleaning products that can remove contaminants and fouling from surfaces, especially porous surfaces, with a reduced impact on the environment. These safer and more sustainable products are still expected to deliver performance at parity to traditional products. Due to the limited set of natural or sustainable materials that meet these needs, formulating safe and environmentally-friendly cleaning compositions remains a challenge. Thus, there is a need for improved cleaning compositions that are effective for penetrating porous surfaces and that reduce total dependency on synthetically-derived ingredients.

### BRIEF SUMMARY OF THE INVENTION

The subject invention provides microbial-derived products, as well as methods of their use, to maintain and/or improve the cleanliness and appearance of porous and non-porous surfaces by, for example, efficiently removing contaminants from these surfaces. Such contaminants can include, but are not limited to, paint, ink, dye, algae, mold, food particles, fat, oil, grease, dirt, scale, and/or biofilm. In certain specific embodiments, the compositions and methods are useful for removing graffiti from surfaces, including porous surfaces. In other specific embodiments, the compositions and methods are useful for removing mold and algae from surfaces.

Advantageously the subject invention uses biodegradable ingredients, which can be utilized on their own and/or in combination with traditional cleaning chemicals. In certain embodiments, the subject invention enhances the effects of traditional cleaning compositions when used in combination therewith.

In preferred embodiments, the subject invention provides cleaning compositions comprising one or more glycolipid biosurfactants. In some embodiments, the cleaning compositions further comprise one or more surfactants, one or more solvents, one or more alkaline soaps, one or more acids, one or more bleaching agents and/or one or more disinfectants in combination with the glycolipid(s).

The surfactant(s) can be any nonionic, cationic, anionic or zwitterionic surfactant, or a blend of two or more of these types. Preferably, the surfactant is a non-biological surfactant. Furthermore, the solvent(s) can be any known solvent that is compatible with the glycolipid and/or the surfactant, such as, for example, glycol ethers, dibasic esters, ketones, terpenes, and/or water.

Glycolipid biosurfactants according to the subject invention include, for example, sophorolipids, mannosylerythritol lipids, rhamnolipids, trehalose lipids and/or cellobiose lipids. The glycolipids can be utilized in the form in which they are produced naturally by microorganisms, and/or they can be subjected to chemical treatments to, for example, alter the chemical structure and/or function of the molecule. In some embodiments, a mixture of glycolipids and/or derivatives of glycolipids can be used depending on, for example, the surface or contaminant being cleaned.

In certain embodiments, the glycolipid is a sophorolipid (SLP), including any form, isoform or isomer thereof, such as, for example, acidic (linear) SLP and lactonic SLP. Further included are mono-acetylated SLP, di-acetylated SLP, esterified SLP, etherified SLP, SLP with varying hydrophobic chain lengths, SLP with amino acid complexes attached, and others, including those that are and/or are not specifically exemplified within this disclosure.

In certain embodiments, the glycolipid is a mannosylerythritol lipid (MEL), including any form, isoform or isomer thereof, such as, for example, for example, tri-acylated, di-acylated, mono-acylated, tri-acetylated, di-acetylated, mono-acetylated and non-acetylated MEL. Other mannose-based substances/MEL-like substances that exhibit similar structures and similar properties, can also be used according to the subject invention, e.g., mannosyl-mannitol lipids (MML), mannosyl-arabitol lipids (MAL), and/or mannosyl-ribitol lipids (MRL).

In certain embodiments, the glycolipids and glycolipid blends according to the present invention can serve as active ingredients in environmentally-friendly cleaning compositions for porous surfaces and to enhance the cleaning of non-porous surfaces. In certain embodiments, the glycolipids and glycolipid blends serve as enhancers for traditional cleaning compounds.

In certain embodiments, the cleaning composition according to the subject invention is effective due to amphiphile-mediated penetration of pores in the contaminated surface. For example, in some embodiments, a SLP will form a micelle, wherein the micelle is less than about 100 μm, less than about 10 μm, less than about 1 μm, less than about 100 nm, less than about 50 nm, less than about 25 nm, less than about 15 nm or less than about 10 nm, less than about 5 nm, or less than about 2 nm in size. The small size and amphiphilic properties of the micelle allow for enhanced penetration into pores so that greater contact can be made with the contaminant therein. In some embodiments, the glycolipid serves as a vehicle for facilitating the transport of solvents or other cleaning chemicals into the pores of the contaminated surface.

Optionally, the conditioning composition can further comprise one or more other components, including, for example, essential oils, botanical extracts, cross-linking agents, chelators, fatty acids, alcohols, pH adjusting agents, reducing agents, syndetics, buffers, enzymes, dyes, colorants, fragrances, preservatives, emulsifiers, foaming agents, polymers, thickeners and/or viscosity modifiers.

In preferred embodiments, the subject invention further provides a method for cleaning porous surfaces and/or for improving the cleaning of non-porous surfaces by applying a cleaning composition according to the subject invention to the surface.

In certain embodiments, the surface is a porous material, wherein the contaminant is present at the surface of the material and/or in the pores of the material. In some embodiments, the method is particularly useful for removing contaminants that are challenging to remove from porous surfaces, including, for example, graffiti, paint, permanent inks, dyes, and mold and algae. Furthermore, the methods can be used to enhance the efficiency of cleaning these and other contaminants from non-porous surfaces.

The cleaning composition can be applied to the surface by spraying using, for example, a spray bottle or a pressurized spraying device. The cleaning composition can also be applied using a cloth or a brush, wherein the composition is rubbed, spread or brushed onto the surface. Furthermore, the cleaning composition can be applied to the surface by dipping, dunking or submerging the surface into a container having the cleaning composition therein.

In one embodiment, the surface is allowed to soak with the cleaning composition thereon for a sufficient time to remove the contaminant. For example, soaking can occur for up to 5 minutes to 24 hours or more, as needed.

In one embodiment, the method further comprises the step of removing the cleaning composition and contaminant from the surface. This can be achieved by, for example, rinsing or spraying water onto the surface, and/or rubbing or wiping the surface with a cloth until the cleaning composition and contaminant have been freed from the surface. Rinsing or spraying with water can be performed before and/or after rubbing or wiping the surface with a cloth. In some embodiments, the spraying is performed under elevated pressure and/or elevated temperature.

In another embodiment, mechanical methods can be used to remove the contaminant and/or cleaning composition from the surface after application of the cleaning composition. For example, a sandblaster, agitator, drill, hammer, sandpaper, or scraper can be used for freeing contaminants from surfaces that are particularly difficult to remove due to, for example, the amount of contaminant or the type of contaminant.

Advantageously, the subject compositions and methods improve the safety and environmental impact of cleaning difficult-to-remove contaminants in, for example, public places, households, commercial, healthcare and industrial settings and in the presence of humans, plants and animals. Additionally, the compositions and methods utilize components that are biodegradable and toxicologically safe, thereby reducing the quantities of harsh cleaning chemicals needed to achieve a desired level of cleaning.

### DETAILED DESCRIPTION

The subject invention provides microbial-derived products, as well as methods of their use, to maintain and/or improve the cleanliness and appearance of porous and non-porous surfaces by, for example, efficiently removing contaminants from these surfaces.

### Selected Definitions

As used herein, a “green” compound or material means at least 95% derived from natural, biological and/or renewable sources, such as plants, animals, minerals and/or microorganisms, and furthermore, the compound or material is biodegradable. Additionally, in some embodiments, “green” compounds or materials are minimally toxic to humans and can have a LD50>5000 mg/kg. A “green” product preferably does not contain any of the following: non-plant based ethoxylated surfactants, linear alkylbenzene sulfonates (LAS), ether sulfates surfactants or nonylphenol ethoxylate (NPE). In certain preferred embodiments, the glycolipid molecules, including derivatized glycolipid molecules, described herein are “green” compounds with minimal toxicity to users.

As used herein, a “biofilm” is a complex aggregate of microorganisms, such as bacteria, yeast, or fungi, wherein the cells adhere to each other and/or to a surface using an extracellular matrix. The cells in biofilms are physiologically distinct from planktonic cells of the same organism, which are single cells that can float or swim in liquid medium.

As used herein, “contaminant” refers to any substance that causes another substance or object to become fouled or impure. Contaminants can be living or non-living and can be inorganic or organic substances or deposits. Furthermore, contaminants can include, but are not limited to, paints, inks and dyes; hydrocarbons, such as petroleum or asphaltenes; fats, oils and greases (FOG), such as cooking grease, plant-based oils, and lard; lipids; waxes, such as paraffin; resins; microorganisms, such as bacteria, biofilms, viruses, fungi, molds, mildews, protozoa, parasites or another infectious microorganisms; stains; or any other substances referred to as, for example, dirt, dust, scale, sludge, crud, slag, grime, scum, plaque, buildup, or residue.

As used herein, “fouling” means the accumulation or deposition of contaminants on a surface of, for example, a piece of equipment in such a way as to compromise the structural and/or functional integrity of the equipment. Fouling can cause clogging, plugging, deterioration, corrosion, and other problems associated therewith, and can occur on both metallic and non-metallic materials and/or surfaces. Fouling that occurs as a result of living organisms, for example, biofilms, is referred to as “biofouling.”

As used herein, “cleaning” as used in the context of contaminants or fouling means removal or reduction of contaminants from a material and/or surface.

As used herein, to “disinfect” means to control or substantially control a deleterious microorganism in 10 minutes or less, preferably in 5 minutes or less, more preferably in 2 minutes or less, after the time of contact between the composition and the deleterious microorganism (i.e., exposure time).

As used herein, “control” in the context of a microorganism means killing, immobilizing, destroying, removing, reducing population numbers of, and/or otherwise rendering the microorganism incapable of reproducing and/or causing substantial harm or fouling.

In preferred embodiments, the deleterious microorganisms are “substantially controlled,” meaning at least 90%, preferably at least 95%, or more preferably, at least 99% of the microorganism's population within a specified area is controlled.

In certain preferred embodiments, 100% of the deleterious microorganism is controlled, meaning the surface and/or material has been “sanitized.”

As used herein, a “deleterious” or “pathogenic” microorganism refers to any single-celled or acellular organism that is capable of causing an infection, disease or other form of harm in another organism. As used herein, pathogenic microorganisms are infectious agents and can include, for example, bacteria, cyanobacteria, biofilms, viruses, virions, viroids, fungi, molds, mildews, protozoa, prions, and algae. In certain embodiments, a deleterious microorganism can include multicellular organisms, such as, for example, certain parasites, helminths, nematodes and/or lichens.

As used herein, “preventing” a situation or occurrence refers to avoiding, delaying, forestalling, or minimizing the onset of a particular sign or symptom of the situation or occurrence. Prevention can, but is not required to be, absolute or complete, meaning the situation or occurrence may still develop at a later time. Prevention can include reducing the severity of the onset of situation or occurrence, and/or inhibiting the progression of the situation or occurrence to one that is more severe.

As used herein, “surfactant” refers to a substance or compound that reduces surface tension when dissolved in water or water solutions, or that reduces interfacial tension between two liquids, or between a liquid and a solid. The term “surfactant” thus includes cationic, anionic, nonionic, zwitterionic, amphoteric agents and/or combinations thereof. By “biosurfactant” is meant a surfactant produced by a living cell and/or using naturally-derived sources.

As used herein, “base surfactant” refers to a surfactant or amphiphilic molecule that exhibits a strong tendency to adsorb at interfaces in a relatively ordered fashion, oriented perpendicular to the interface.

As used herein, the term “syndetic” (meaning to join or link together, as in mixing water and oil) refers to a relatively weak amphiphile that exhibits a significant ability to adsorb at an oil-water interface (from either the water phase, hence a “hydrophilic syndetic,” or from the oil phase, hence a “hydrophobic syndetic”) only when the interface already bears an adsorbed layer of a base surfactant or mixture of base surfactants. Adsorption of syndetics at oil-water interfaces is thought to affect the spacing and/or the order of the adsorbed ordinary surfactants in a manner that is highly beneficial to the production of very low oil-water interfacial tensions, which in turn increases the solubilization of oils and/or the removal of oils from solid materials and/or surfaces.

As used herein, an “isolated” or “purified” nucleic acid molecule, polynucleotide, polypeptide, protein or organic compound, such as a small molecule, is substantially free of other compounds, such as cellular material, with which it is associated in nature. A purified or isolated polynucleotide (ribonucleic acid (RNA) or deoxyribonucleic acid (DNA)) is free of the genes or sequences that flank it in its naturally-occurring state. A purified or isolated polypeptide is free of other molecules, or the amino acids that flank it, in its naturally-occurring state. An “isolated” strain means that the strain is removed from the environment in which it exists in nature. Thus, the isolated strain may exist as, for example, a biologically pure culture, or as spores (or other forms of the strain).

In certain embodiments, purified compounds are at least 60% by weight the compound of interest. Preferably, the preparation is at least 75%, more preferably at least 90%, and most preferably at least 99%, by weight the compound of interest. For example, a purified compound is one that is at least 90%, 91%, 92%, 93%, 94%, 95%, 98%, 99%, or 100% (w/w) of the desired compound by weight. Purity is measured by any appropriate standard method, for example, by column chromatography, thin layer chromatography, or high-performance liquid chromatography (HPLC) analysis.

Ranges provided herein are understood to be shorthand for all of the values within the range. For example, a range of 1 to 20 is understood to include any number, combination of numbers, or sub-range from the group consisting 1, 2, 3, 4, 5, 6, 7, 8, 9, 10, 11, 12, 13, 14, 15, 16, 17, 18, 19 and 20, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

As used herein, “reduces” means a negative alteration, and “increases” means a positive alteration, wherein the alteration is at least 0.001%, 0.01%, 0.1%, 1%, 5%, 10%, 15%, 20%, 25%, 30%, 35%, 45%, 50%, 55%, 60%, 65%, 70%, 75%, 80%, 85%, 90%, 95%, 99%, or 100%, inclusive of all values therebetween.

The transitional term “comprising,” which is synonymous with “including,” or “containing,” is inclusive or open-ended and does not exclude additional, unrecited elements or method steps. By contrast, the transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed invention. Use of the term “comprising” contemplates other embodiments that “consist” or “consist essentially” of the recited component(s).

Unless specifically stated or obvious from context, as used herein, the term “or” is understood to be inclusive. Unless specifically stated or obvious from context, as used herein, the terms “a,” “an” and “the” are understood to be singular or plural.

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value.

The recitation of a listing of chemical groups in any definition of a variable herein includes definitions of that variable as any single group or combination of listed groups. The recitation of an embodiment for a variable or aspect herein includes that embodiment as any single embodiment or in combination with any other embodiments or portions thereof. All references cited herein are hereby incorporated by reference.

### Cleaning Compositions

In preferred embodiments, the subject invention provides cleaning compositions comprising one or more glycolipid biosurfactants. In some embodiments, the cleaning compositions further comprise one or more additional surfactants, one or more solvents, one or more alkaline soaps, one or more acids, one or more bleaching agents and/or one or more disinfectants in combination with the glycolipid(s).

Biosurfactants are amphiphilic molecules consisting of both hydrophobic (e.g., a fatty acid) and hydrophilic domains (e.g., a sugar). Due to their amphiphilic nature, biosurfactants can partition at the interfaces between different fluid phases such as oil/water or water/air interfaces. Unlike synthetic surfactants, biosurfactants can be effective in hot or cold water, and at either extreme of the pH scale. Additionally, biosurfactants are biodegradable and non-toxic.

Glycolipid biosurfactants according to the subject invention include, for example, sophorolipids, mannosylerythritol lipids, rhamnolipids, trehalose lipids and/or cellobiose lipids. The glycolipids can be utilized in the form in which they are produced naturally by microorganisms, and/or they can be isolated and further subjected to chemical treatments to, for example, alter the chemical structure and/or function of the molecule. In some embodiments, a mixture of glycolipids and/or derivatives of glycolipids can be used depending on, for example, the surface or contaminant being cleaned.

In certain embodiments of the present invention, sophorolipids (SLP) are specific glycolipids of interest. Sophorolipids are glycolipid biosurfactants produced by, for example, various yeasts of the Starmerella clade. SLP consist of a disaccharide sophorose linked to long chain hydroxy fatty acids. They can comprise a partially acetylated 2-O-β-D-glucopyranosyl-D-glucopyranose unit attached β-glycosidically to 17-L-hydroxyoctadecanoic or 17-L-hydroxy-Δ9-octadecenoic acid. The hydroxy fatty acid can have, for example, 11 to 20 carbon atoms, and may contain one or more unsaturated bonds. Furthermore, the sophorose residue can be acetylated on the 6- and/or 6′-position(s). The fatty acid carboxyl group can be free (acidic or linear form) or internally esterified at the 4″-position (lactonic form). In most cases, fermentation of SLP results in a mixture of hydrophobic (water-insoluble) SLP, including, e.g., lactonic SLP, mono-acetylated linear SLP and di-acetylated linear SLP, and hydrophilic (water-soluble) SLP, including, e.g., non-acetylated linear SLP.

As used herein, the term “sophorolipid,” “sophorolipid molecule,” “SLP” or “SLP molecule” includes all forms, and isomers thereof, of SLP molecules, including, for example, acidic (linear) SLP and lactonic SLP. Further included are mono-acetylated SLP, di-acetylated SLP, esterified SLP, SLP with varying hydrophobic chain lengths, SLP with fatty acid-amino acid complexes attached, and other, including those that are and/or are not described within in this disclosure.

In some embodiments, SLP molecules can be represented by General Formula (1) and/or General Formula (2), and include 30 or more types of structural homologues having different fatty acid chain lengths (R³), and, in some instances, having an acetylation or protonation at R¹ and/or R².

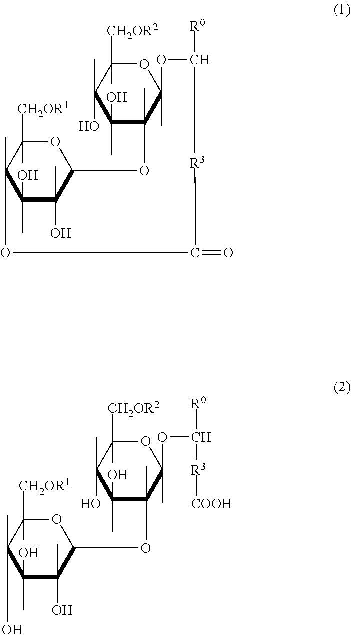

In General Formula (1) or (2), R⁰ can be either a hydrogen atom or a methyl group. R¹ and R² are each independently a hydrogen atom or an acetyl group. R³ is a saturated aliphatic hydrocarbon chain, or an unsaturated aliphatic hydrocarbon chain having at least one double bond, and may have one or more Substituents.

Non-limiting examples of the Substituents include halogen atoms, hydroxyl, lower (C1-6) alkyl groups, halo lower (C1-6) alkyl groups, hydroxy lower (C1-6) alkyl groups, halo lower (C1-6) alkoxy groups, and others, such as those that are described within the present disclosure. R³ can have, for example, 11 to 20 carbon atoms.

Fermentation of yeast cells in a culture substrate including a sugar and/or lipids and fatty acids with carbon chains of differing length can be used to produce a variety of SLP. The yeast Starmerella (Candida) bombicola is one of the most widely recognized producers of SLP. Typically, the yeast produces both lactonic and linear SLP during fermentation, with about 60-70% of the SLP comprising lactonic forms, and the remainder comprising lactonic forms.

In certain embodiments, the ratio of linear SLP to lactonic SLP in the composition is the ratio obtained from standard fermentation processes. In certain embodiments, the ratio is adjusted. For example, the percentage ratio of linear to lactonic SLP can be from 1:99 to 99:1, 10:90 to 90:10, 20:80 to 80:20, 30:70 to 70:30, 40:60 to 60:40, or 50:50.

In certain embodiments, mannosylerythritol lipids (MEL) are a glycolipid of interest. MEL comprise either 4-O—B-D-mannopyranosyl-meso-erythritol or 1-O—B-D-mannopyranosyl-meso-erythritol as the hydrophilic moiety, and fatty acid groups and/or acetyl groups as the hydrophobic moiety. One or two of the hydroxyls, typically at the C4 and/or C6 of the mannose residue, can be acetylated. Furthermore, there can be one to three esterified fatty acids, from 8 to 12 carbons or more in chain length.

MEL and MEL-like substances (e.g., mannose-based substances) are produced mainly by Pseudozyma spp. (e.g., P. aphidis) and Ustilago spp. (e.g., U. maydis), with significant variability among MEL structures produced by each species. Certain mannose-based substances having similar properties to MEL can also be produced by Meyerozyma guilliermondii yeasts.

MEL are non-toxic and are stable at wide temperatures and pH ranges. Furthermore, MEL can be used without any additional preservatives MEL can be produced in more than 93 different combinations that fall under 5 main categories: MEL A, MEL B, MEL D, Tri-acetylated MEL A, and Tri-acetylated MEL B/C. These molecules can be modified, either synthetically or in nature. For example, MEL can comprise different carbon-length chains or different numbers of acetyl and/or fatty acid groups.

MEL molecules and/or modified forms thereof according to the subject invention can include, for example, tri-acylated, di-acylated, mono-acylated, tri-acetylated, di-acetylated, mono-acetylated and non-acetylated MEL, as well as stereoisomers and/or constitutional isomers thereof.

Other mannose-based substances/MEL-like substances that exhibit similar structures and similar properties, can also be used according to the subject invention, e.g., mannosyl-mannitol lipids (MML), mannosyl-arabitol lipids (MAL), and/or mannosyl-ribitol lipids (MRL).

In certain embodiments, a mixture of SLP and MEL is used in the cleaning composition, wherein the ratio of SLP to MEL is from 1:99 to 99:1, 10:90 to 90:10, 20:80 to 80:20, 30:70 to 70:30, 40:60 to 60:40, or 50:50.

In certain embodiments, the glycolipids and glycolipid blends according to the present invention can serve as active ingredients in environmentally-friendly cleaning compositions for porous surfaces and to enhance the cleaning of non-porous surfaces. In certain embodiments, the glycolipids and glycolipid blends serve as enhancers for traditional cleaning compounds.

In certain embodiments, the cleaning composition according to the subject invention is effective due to amphiphile-mediated penetration of pores in the contaminated surface. For example, in some embodiments, a SLP will form a micelle, wherein the micelle is less than about 100 μm, less than about 10 μm, less than about 1 μm, less than about 100 nm, less than about 50 nm, less than about 25 nm, less than about 15 nm or less than about 10 nm, less than about 5 nm, or less than about 2 nm in size. The small size and amphiphilic properties of the micelle allow for enhanced penetration into pores so that greater contact can be made with the contaminant therein. In some embodiments, the glycolipid serves as a vehicle for facilitating the transport of solvents or other cleaning chemicals into the pores of the contaminated surface.

The amount of the glycolipid(s) in the composition can range from about, for example, 1 ppm to 25 wt %, 5 ppm to 20 wt %, 10 ppm to 15 wt %, 25 ppm to 10 wt %, 50 ppm to 8 wt %, or 100 ppm to 5 wt %.

In certain embodiments, the composition comprises the glycolipid(s) in combination with one or more chemical surfactants. The surfactant(s) can be any nonionic, cationic, anionic or zwitterionic surfactant, or a blend of two or more of these types. Surfactants are surface active agents having two functional groups, namely a hydrophilic (water-soluble) or polar group and a hydrophobic (oil-soluble) or non-polar group. The hydrophobic group is usually a long hydrocarbon chain (C8-C18), which may or may not be branched, while the hydrophilic group is formed by moieties such as carboxylates, sulfates, sulfonates (anionic), alcohols, polyoxyethylenated chains (nonionic) and quaternary ammonium salts (cationic).

Surfactants according to the subject compositions and methods include, but are not limited to: ammonium lauryl sulfate, sodium lauryl sulfate (also called SDS, sodium dodecyl sulfate), alkyl-ether sulfates sodium laureth sulfate (also known as sodium lauryl ether sulfate (SLES)), sodium myreth sulfate; docusates, dioctyl sodium sulfosuccinate, perfluorooctanesulfonate (PFOS), perfluorobutanesulfonate, linear alkylbenzene sulfonates (LABs), alkyl-aryl ether phosphates, alkyl ether phosphate; carboxylates, alkyl carboxylates (soaps), sodium stearate, sodium lauroyl sarcosinate, carboxylate-based fluorosurfactants, perfluorononanoate, perfluorooctanoate; cationic surfactants, pH-dependent primary, secondary, or tertiary amines, octenidine dihydrochloride, permanently charged quaternary ammonium cations, alkyltrimethylammonium salts, cetyl trimethylammonium bromide (CTAB) (a.k.a. hexadecyl trimethyl ammonium bromide), cetyl trimethylammonium chloride (CTAC), cetylpyridinium chloride (CPC), benzalkonium chloride (BAC), benzethonium chloride (BZT), 5-Bromo-5-nitro-1,3-dioxane, dimethyldioctadecylammonium chloride, cetrimonium bromide, dioctadecyldi-methylammonium bromide (DODAB); zwitterionic (amphoteric) surfactants, sultaines CHAPS (3-[(3-Cholamidopropyl)dimethylammonio]-1-propanesulfonate), cocamidopropyl hydroxysultaine, betaines, cocamidopropyl betaine, phosphatidylserine, phosphatidylethanolamine, phosphatidylcholine, sphingomyelins; nonionic surfactants, ethoxylate, long chain alcohols, fatty alcohols, cetyl alcohol, stearyl alcohol, cetostearyl alcohol, oleyl alcohol, polyoxyethylene glycol alkyl ethers (Brij): CH3-(CH2)10-16-(O—C2H4)1-25-OH (octaethylene glycol monododecyl ether, pentaethylene glycol monododecyl ether), polyoxypropylene glycol alkyl ethers: CH3-CH2)10-16-(O—C3H6)1-25-OH, glucoside alkyl ethers: CH3-(CH2)10-16-(O-Glucoside)1-3-OH (decyl glucoside, lauryl glucoside, octyl glucoside), polyoxyethylene glycol octylphenol ethers: C8H17-(C6H4)-(O—C2H4)1-25-OH (Triton X-100), polyoxyethylene glycol alkylphenol ethers: C9H19-(C6H4)-(O—C2H4)1-25-OH (nonoxynol-9), glycerol alkyl esters (glyceryl laurate), polyoxyethylene glycol sorbitan alkyl esters (polysorbate), sorbitan alkyl esters (spans), cocamide MEA, cocamide DEA, dodecyldimethylamine oxide (a.k.a. lauramine oxide), copolymers of polyethylene glycol and polypropylene glycol (poloxamers), and polyethoxylated tallow amine (POEA).

Anionic surfactants contain anionic functional groups at their head, such as sulfate, sulfonate, phosphate, and carboxylates. Prominent alkyl sulfates include ammonium lauryl sulfate, sodium lauryl sulfate (also called SDS, sodium dodecyl sulfate) and the related alkyl-ether sulfates sodium laureth sulfate, also known as sodium lauryl ether sulfate (SLES), and sodium myreth sulfate. Carboxylates are the most common surfactants and comprise the alkyl carboxylates (soaps), such as sodium stearate.

Surfactants with cationic head groups include: pH-dependent primary, secondary, or tertiary amines; octenidine dihydrochloride; permanently charged quaternary ammonium cations such as alkyltrimethylammonium salts: cetyl trimethylammonium bromide (CTAB) a.k.a. hexadecyl trimethyl ammonium bromide, cetyl trimethylammonium chloride (CTAC); cetylpyridinium chloride (CPC); benzalkonium chloride (BAC); benzethonium chloride (BZT); 5-Bromo-5-nitro-1,3-dioxane; dimethyldioctadecylammonium chloride; cetrimonium bromide; and dioctadecyldi-methylammonium bromide (DODAB).

Zwitterionic (amphoteric) surfactants have both cationic and anionic centers attached to the same molecule. The cationic part is based on primary, secondary, or tertiary amines or quaternary ammonium cations. The anionic part can be more variable and include, for example, sulfonates. Zwitterionic surfactants commonly have a phosphate anion with an amine or ammonium, such as is found in the biologically-derived phospholipids phosphatidylserine, phosphatidylethanolamine, phosphatidylcholine, and sphingomyelins.

A surfactant with a non-charged hydrophilic part, e.g. ethoxylate, is non-ionic. Many long chain alcohols exhibit some surfactant properties.

The amount of the surfactant in the composition can range from, for example, 0 to 25 wt %, 0.5 to 20 wt %, 1 to 15 wt %, 1.5 to 10 wt %, or 2 to 5 wt %. In certain preferred embodiments, the amount is from 0 to 5 wt %.

In certain specific embodiments, the surfactant(s) include lauramine oxide.

In some embodiments, the cleaning compositions further comprise one or more solvents.

The solvent(s) can be any known solvent that is compatible with the glycolipid and/or the surfactant, including water.

In certain embodiments, the solvents are glycol ethers. Glycol ethers, as used herein are defined by the following formula: R—(OCH₂CH₂)ₙ—OR′
where: n=1, 2, or 3;
   R=Alkyl C7 or less, or phenyl or alkyl substituted phenyl;
   R′═H or alkyl C7 or less, or
   OR′ consisting of a carboxylic acid ester, sulfate, phosphate, nitrate, or sulfonate.

Examples of glycol ethers include, for example, monobutyl glycol, tributyl glycol, tripropylene glycol methyl ether, ethylene glycol monomethyl ether, ethyleneglycol n-butyl ether, diethyleneglycol n-butyl ether, triethyleneglycol n-butyl ether, propyleneglycol n-butyl ether, dipropyleneglycol n-butyl ether, tripropyleneglycol n-butyl ether, ethyleneglycol n-pentyl ether, diethyleneglycol n-pentyl ether, triethyleneglycol n-pentyl ether, propylene-glycol n-pentyl ether, dipropyleneglycol n-pentyl ether, tripropyleneglycol n-pentyl ether, ethyleneglycol n-hexyl ether, diethyleneglycol n-hexyl ether, triethyleneglycol n-hexyl ether, propyleneglycol n-hexyl ether, dipropyleneglycol n-hexyl ether, tripropyleneglycol n-hexyl ether, ethyleneglycol phenyl ether, diethyleneglycol phenyl ether, triethyleneglycol phenyl ether, propyleneglycol phenyl ether, dipropyleneglycol phenyl ether, tripropyleneglycol phenyl ether, ethyleneglycol benzyl ether, diethyleneglycol benzyl ether, triethyleneglycol benzyl ether, propyleneglycol benzyl ether, dipropyleneglycol benzyl ether, tripropyleneglycol benzyl ether. ethyleneglycol isobutyl ether, diethyleneglycol isobutyl ether, triethyleneglycol isobutyl ether, propyleneglycol isobutyl ether, dipropyleneglycol isobutyl ether. tripropyleneglycol isobutyl ether. ethyleneglycol isopentyl ether, diethyleneglycol isopentyl ether, triethyleneglycol isopentyl ether, propyleneglycol isopentyl ether, dipropyleneglycol isopentyl ether, tripropyleneglycol isopentyl ether, ethyleneglycol isohexyl ether, diclhyleneglycol isohexyl ether, triethyleneglycol isohexyl ether, propyleneglycol isohexyl ether, dipropyleneglycol isohexyl ether. tripropyleneglycol isohexyl ether. ethyleneglycol n-butyl methyl ether. diethyleneglycol n-butyl methyl ether triethyleneglycol n-butyl methyl ether, propyleneglycol n-butyl methyl ether, dipropyleneglycol n-butyl methyl ether, tripropyleneglycol n-butyl methyl ether, ethyleneglycol n-pentyl methyl ether, diethyleneglycol n-pentyl methyl ether, triethyleneglycol n-pentyl methyl ether, propyleneglycol n-pentyl methyl ether, dipropyleneglycol n-pentyl methyl ether, tripropyleneglycol n-pentyl methyl ether, ethyleneglycol n-hexyl methyl ether, diethyleneglycol n-hexyl methyl ether, triethyleneglycol n-hexyl methyl ether, propyleneglycol n-hexyl methyl ether, dipropyleneglycol n-hexyl methyl ether. tripropyleneglycol n-hexyl methyl ether, ethyleneglycol phenyl methyl ether. diethyleneglycol phenyl methyl ether, triethyleneglycol phenyl methyl ether, propyleneglycol phenyl methyl ether, dipropyleneglycol phenyl methyl ether, tripropyleneglycol phenyl methyl ether, ethyleneglycol benzyl methyl ether, diethyleneglycol benzyl methyl ether, triethyleneglycol benzyl methyl ether, propyleneglycol benzyl methyl ether, dipropyleneglycol benzyl methyl ether, tripropyleneglycol benzyl methyl ether, ethyleneglycol isobutyl methyl ether, diethyleneglycol isobutyl methyl ether, triethyleneglycol isobutyl methyl ether, propyleneglycol isobutyl methyl ether, dipropyleneglycol isobutyl methyl ether, tripropyleneglycol isobutyl methyl ether, ethyleneglycol isopentyl methyl ether, diethyleneglycol isopentyl methyl ether, triethyleneglycol isopentyl methyl ether, propyleneglycol isopentyl methyl ether, dipropyleneglycol isopentyl methyl ether, tripropyleneglycol isopentyl methyl ether, ethyleneglycol isohexyl methyl ether, diethyleneglycol isohexyl methyl ether, triethyleneglycol isohexyl methyl ether, propyleneglycol isohexyl methyl ether, dipropyleneglycol isohexyl methyl ether, tripropyleneglycol isohexyl methyl ether, propyleneglycol n-propyl ether, dipropyleneglycol n-propyl ether, tripropyleneglycol n-propyl ether, propyleneglycol isopropyl ether, dipropyleneglycol isopropyl ether, tripropyleneglycol isopropyl ether, propyleneglycol n-propyl methyl ether, dipropyleneglycol n-propyl methyl ether, tripropyleneglycol n-propyl methyl ether, propyleneglycol isopropyl methyl ether, dipropyleneglycol isopropyl methyl ether, tripropyleneglycol isopropyl methyl ether, and mixtures thereof.

In certain embodiments, the solvents are dibasic esters. As used herein, the term “dibasic ester” refers to compounds having the general formula R—OOC—Y—COO—R″, wherein Y, R′, and R″ denote any organic compound (such as alkyl, aryl, or silyl groups), including those bearing heteroatom containing substituent groups. In certain embodiments, Y is a saturated or unsaturated hydrocarbon, and R′ and R″ are alkyl or aryl groups. Non-limiting examples of dibasic esters according to the subject invention include dialkyl adipate, dialkyl succinate, dialkyl azelate, and dialykl glutarate.

In certain embodiments, the solvents are ketones. As used herein, the term “ketone” refers to compounds having the general formula R′—CO—R″, wherein R′ and R″ are alkyl or aryl groups, and may be the same or different from each other. Non-limiting examples of ketones according to the subject invention include acetone, methyl ethyl ketone, kethyl isobutyl ketone, mesityl oxide and isophorone.

In certain embodiments, the solvents are ketals. As used herein, the term “ketal” refers to compounds having the general formula R′2C(OR″)2, wherein R′ and R″ are alkyl or aryl groups. Non-limiting examples of ketals according to the subject invention include acetone peroxide, methyl ethyl ketone peroxide, and solketal.

In certain embodiments, the solvents can comprise one or more terpenes. As used herein, the term “terpene” refers to a class of compounds derived from isoprene, which has the molecular formula C₅H₈. The basic molecular formula for terpenes comprises (C₅H₈)ₙ, where n is the number of linked isoprene units. In some embodiments, the terpenes are derived from plants, such as citrus plants or pine trees. Terpenes can include but are not limited to, DL-limonene, orange terpenes, lemon terpenes, grapefruit terpenes, orange oil, lemon oil, other citrus terpenes, other citrus oils, geraniol, terpineol, dipentene, myrcene, linalool, cymene, terpenoids, sesquiterpenes, and pinene.

The solvents of the subject invention can be utilized individually or in blends of more than one type. In certain embodiments, the total concentration of each solvent in the cleaning composition is, for example, about 1 to 99 wt %, 2 to 95 wt %, 3 to 85%, 4 to 75 wt %, 5 to 65 wt %, 6 to 55 wt %, 7 to 45 wt %, 8 to 35 wt %, 9 to 25 wt %, 10 to 15 wt %, 1 to 10 wt %, 2 to 8 wt %, or 3 to 7 wt %.

In certain embodiments, the cleaning composition comprises one or more alkaline soaps, one or more acids, one or more bleaching agents and/or one or more disinfectants in combination with the glycolipid(s), surfactants and/or solvents. Each of these additional ingredients can be included in the composition at a concentration of, for example, 0 to 99 wt %, 0.1 to 95 wt %, 0.5 to 85%, 0.75 to 75 wt %, 1 to 65 wt %, 5 to 55 wt %, 7 to 45 wt %, 8 to 35 wt %, 9 to 25 wt %, 10 to 15 wt %, 1 to 10 wt %, 2 to 8 wt %, or 3 to 7 wt %.

Exemplary alkaline soaps according to the subject invention include, but are not limited to, sodium hydroxide, potassium hydroxide and fatty acid salts of sodium and/or potassium, such as potassium cocoate.

Exemplary acids according to the subject invention include, but are not limited to, organic acids, such as, for example, acetic acid, citric acid, lactic acid, butyric acid, sorbic acid, benzoic acid, formic acid, fumaric acid, propionic acid, ascorbic acid, glyoxylic acid, malonic acid, pyruvic acid, oxalic acid, uric acid, malic acid, tartaric acid and/or analogs thereof; and inorganic acids such as, for example, sulfuric acid, nitric acid, phosphoric acid, hydrochloric acid, hydrofluoric acid, boric acid and analogs thereof.

Exemplary bleaching agents according to the subject invention include, but are not limited to, sodium hypochlorite, chlorine, calcium hypochlorite and hydrogen peroxide. In certain embodiments, the bleaching agent can also serve as a disinfectant or antimicrobial.

Exemplary disinfectants according to the subject invention include, but are not limited to, thymol, citric acid, lactic acid, amine oxides (e.g., LDAO, DDA, or myristamine oxide), phenolics, quaternary ammonium compounds, such as benzalkonium chlorides and/or substituted benzalkonium chlorides, di(C6-C14)alkyl di short chain (C1-4 alkyl and/or hydroxyalkl) quatemaryammonium salts, N-(3-chloroallyl)hexaminium chlorides, benzethonium chloride, methylbenzethonium chloride, and cetylpyridinium chloride. Other quaternary compounds include the group consisting of dialkyldimethyl ammonium chlorides, alkyl dimethylbenzylammonium chlorides, dialkylmethyl-enzylmmonium chlorides, and mixtures thereof, and biguanides such as polyhexamethylene biguanide hydrochloride, p-chloro-henyl biguanide, 4-chlorobenzhydryl biguanide, and halogenated hexidines such as, but not limited to, chlorhexidine(1,1′-hexamethylene-bis-5-(4-chlorophenyl biguanide) (CHG).

Other suitable additives can include, for example, essential oils, botanical extracts, cross-linking agents, chelators, fatty acids, alcohols, pH adjusting agents, reducing agents, syndetics, buffers, enzymes, dyes, colorants, fragrances, preservatives, emulsifiers, foaming agents, polymers, thickeners, viscosity modifiers, chelators (e.g., dimercaptosuccinic acid (DMSA), 2,3-dimercaptopropanesulfonic acid (DMPS), alpha lipoic acid (ALA), thiamine tetrahydrofurfuryl disulfide (TTFD), penicillamine, ethylenediaminetetraacetic acid (EDTA), sodium acetate, sodium citrate and citric acid), C8-C14 alcohol ester blends (e.g., EXXATE 900, 1000, 1200 from Exxon Chemical), glycols (e.g., propylene glycol, dipropylene glycol, and triproplylene glycol), acid esters (e.g., methyl oleate and methyl linoleate), diacid esters (e.g., methyl or butyl diesters of glutaric, adipic, and succinic acids), petroleum hydrocarbons, amino acids, amines (e.g., morpholine, 1,3-dimethyl-2-imidazolidinone, 1, 3-propanediamine, 2-amino-1,3-propanediol, and 3-amino propanol), alkanolamines (e.g., triethanolamine, diethanolamine, 2-aminomethyl propanol, and monoethanolamine), n-methyl-2 pyrolidone; water softening agents, sequesterants, corrosion inhibitors, and antioxidants, which are added in amounts effective to perform their intended function. These additives and amounts thereof are well within the skill of the art. Suitable water softening agents include linear phosphates, styrene-maleic acid co-polymers, and polyacrylates. Suitable sequesterants include 1,3-dimethyl-2-immidazolidinone; 1-phenyl-3-isoheptyl-1,3-propanedione; and 2 hydroxy-5-nonylacetophenoneoxime. Examples of corrosion inhibitors include 2-aminomethyl propanol, diethylethanolamine benzotraizole, and methyl benzotriazole. Antioxidants suitable for the present invention include (BHT) 2,6-di-tert-butyl-para-cresol, (BHA) 2,6-di-tert-butyl-para-anisole, Eastman inhibitor O A BM-oxalyl bis(benzylidenehydrazide), and Eastman DTBMA 2,5-di-tert-butylhydroquinone.

### Exemplary Embodiments

In certain exemplary embodiments, the cleaning composition comprises:
I) 100 ppm to 5 wt % of one of more glycolipids; 0 to 5 wt % of a surfactant or blend of surfactants; and the remainder one or more solvents.
II) In one embodiment, the composition is a composition of I), wherein the glycolipids are SLP, MEL, or a mixture of these types of glycolipids.
III) In one embodiment, the composition is a composition of I) or II), wherein the solvents are or include glycol ethers, e.g., monobutyl glycol, tributyl glycol, and/or tripropylene glycol methyl ether.
IV) In one embodiment, the composition is a composition of I), II) or III), wherein the solvents are or include dibasic esters, e.g., dialkyl adipate, dialkyl succinate, and/or dialkyl azelate.
V) In one embodiment, the composition is a composition of I), II), III) or IV), wherein the solvents are or include ketone solvents, e.g., acetone or methyl isobutyl ketone.
VI) In one embodiment, the composition is a composition of I), II), III), IV) or V), wherein the solvents are or include ketals, e.g., acetone peroxide, methyl ethyl ketone peroxide, and/or solketal.
VII) In one embodiment, the composition is a composition of I), II), III), IV), V), or VI), wherein the solvents are or include terpenes, e.g., DL-limonene.
VIII) In one embodiment, the composition is a composition of I), II), III), IV), V), VI) or VII), wherein the solvents are or include water.
IX) In one embodiment, the composition is a composition of I), II), III), IV), V), VI) or VII), wherein the surfactant includes lauramine oxide.
X) In one embodiment, the composition is a blend of any of II) through IX).
XI) In one embodiment, the composition is a composition of any of I) through X), wherein the composition comprises an alkaline soap, e.g., sodium hydroxide or potassium hydroxide, and fatty acid salts of sodium and/or potassium, such as potassium cocoate.
XII) In one embodiment, the composition is a composition of any of I) through XI), wherein the composition comprises an acid, e.g., citric acid, oxalic acid or hydrogen peroxide.
XIII) In one embodiment, the composition is a composition of any of I) through XII), wherein the composition comprises a bleaching agent, e.g., sodium hypochlorite.

### Methods

In preferred embodiments, the subject invention further provides methods for cleaning porous surfaces and/or for improving the cleaning of non-porous surfaces by applying a cleaning composition according to the subject invention to the surface.

In certain embodiments, the surface is a porous material, wherein the contaminant is present at the surface of the material and/or in the pores of the material. Examples of porous materials include, but are not limited to, concrete, brick, ceramics, cinder block, stone, aggregate panels, asphalt, untreated wood, sheetrock, drywall, plaster, stucco and some plastics.

In some embodiments, the method is particularly useful for removing contaminants that are challenging to remove from porous surfaces, including, for example, graffiti, paint, permanent inks, dyes, and mold and algae. Furthermore, the methods can be used to enhance the efficiency of cleaning these and other contaminants from non-porous surfaces, including, for example, treated woods, treated stones, synthetic siding, metal, glass, and certain non-porous plastics.

In some embodiments, the present invention can be used to remove odors emitted from buildings, sidewalks, pools or other structures that are caused by growth of algae and/or mold on the surfaces.

As used herein, “applying” a composition or product refers to contacting it with a target or site such that the composition or product can have an effect on that target or site, specifically, cleaning of a contaminant from the surface. For example, the target contaminated surface may be dipped, submerged, dunked and/or soaked in the cleaning compositions. The compositions also may be injected, dispersed, dispensed, poured, spread, sprayed, rubbed, wiped, brushed or applied to the surface by any other means contemplated by the ordinary skilled artisan.

In certain embodiments, the cleaning composition is applied to the surface by spraying using, for example, a spray bottle or a pressurized spraying device.

In certain preferred embodiments, the composition is sprayed at high pressure to the surface. In preferred embodiments, high pressure is defined as 1,000 psi to 10,000 psi. The exact pressure can vary depending upon the type of contaminant and the type of surface being cleaned. In one embodiment, the pressure can range from about 1,000 to about 2,000 psi for smaller, household-type cleaning, from about 2,000 to about 3,000 psi for moderately-sized tasks, or from 3,000 to about 7,000 or 8,000 psi for larger scale, industrial cleaning jobs.

Power or pressure washers are often used to clean, for example, the sides of buildings and other structures, screens, sidewalks and patios, automobiles, boats, airplanes, lawn equipment, grates, fences, walls, floors, grills and heavy machinery. Advantageously, the subject cleaning compositions, when used as part of a power washer solution, can improve the removal of contaminants over, for example, using water or other cleaning chemicals on their own.

In certain embodiments, the spraying of the composition, whether under higher pressure or standard pressure, can be performed under elevated temperature to further enhance the efficiency of the cleaning. For example, in some embodiments, the spraying is performed at a temperature from about 25° C. to 300° C., 35° C. to 250° C., 45° C. to 200° C. or 55° C. to 150° C.

In one embodiment, the surface is allowed to soak with the cleaning composition thereon for a sufficient time to facilitate the removal of the contaminant. For example, soaking can occur for up to 5 minutes to 72 hours, 10 minutes to 56 hours, 15 minutes to 48 hours, 20 minutes to 36 hours, 25 minutes to 24 hours, or as long as needed.

In one embodiment, the method further comprises the step of removing the cleaning composition and contaminant from the surface. This can be achieved by, for example, rinsing or spraying water onto the surface, and/or rubbing or wiping the surface with a cloth until the cleaning composition and contaminant have been freed from the surface. Rinsing or spraying with water can be performed before and/or after rubbing or wiping the surface with a cloth. In some embodiments, the rinse spraying is performed under elevated pressure and/or elevated temperature, for example, at pressures and/or temperatures outlined above for application of the cleaning composition. In certain embodiments, an abrasive substance is applied concurrently with the pressurized spray, e.g., sandblasting.

In another embodiment, mechanical methods can be used to remove the contaminant and/or cleaning composition from the surface after application of the cleaning composition. For example, an agitator, drill, hammer, sandpaper, or scraper can be used for freeing contaminants from surfaces that are particularly difficult to remove due to, for example, the amount of contaminant or the type of contaminant.

In certain embodiments, the subject invention provides methods for cleaning graffiti, methods for cleaning mold and algae, methods for cleaning permanent inks and dyes, and methods for cleaning food particles and/or pathogens from porous surfaces.

Advantageously, the subject compositions and methods improve the safety and environmental impact of cleaning difficult-to-remove contaminants in, for example, public places, households, commercial, healthcare and industrial settings and in the presence of humans, plants and animals. Additionally, the compositions and methods utilize components that are biodegradable and toxicologically safe, thereby reducing the quantities of harsh cleaning chemicals needed to achieve a desired level of cleaning.

1. A cleaning composition comprising a sophorolipid and/or a mannosylerythritol lipid; lauramine oxide and a solvent selected from glycol ethers, dibasic esters, ketone solvents, ketal solvents, and terpenes.

2-6. (canceled)

7. The cleaning composition of claim 6, comprising a glycol ether selected from monobutyl glycol, tributyl glycol, and tripropylene glycol methyl ether.

8. The cleaning composition of claim 1, comprising a dibasic ester selected from dialkyl adipate, dialkyl succinate, and dialkyl azelate.

9. The cleaning composition of claim 1, comprising a ketone solvent selected from acetone and methyl isobutyl ketone.

10. The cleaning composition of claim 1 wherein the terpene is DL-limonene.

11. The cleaning composition of claim 1, further comprising an alkaline soap, an acid or a bleaching agent.

12. A method for cleaning a contaminant from a surface, wherein the method comprises:
applying a cleaning composition comprising a glycolipid, a surfactant and a solvent to the surface; and removing the cleaning composition and the contaminant from the surface.

13. The method of claim 12, wherein the cleaning composition is applied to the surface by spraying.

14. (canceled)

15. The method of claim 13, wherein the spraying is done using a pressurized spraying device, and wherein the composition is sprayed at a pressure of 1,000 psi to 7,000 psi.

16-20. (canceled)

21. The method of claim 12, wherein removing the cleaning composition and contaminant comprises rinsing or spraying water onto the surface.

22-25. (canceled)

26. The method of claim 12, wherein the surface is brick, ceramic, cinder block, stone, an aggregate panel, asphalt, untreated wood, sheetrock, drywall, plaster, stucco or porous plastic.

27. The method of claim 12, wherein the composition comprises a glycolipid selected from sophorolipids and mannosylerythritol lipids.

28. The method of claim 12, wherein the glycolipid concentration in the composition is from 100 ppm to 5 wt %.

29. (canceled)

30. The method of claim 12, wherein the composition comprises lauramine oxide as a surfactant.

31. The method of claim 12, wherein the composition comprises a solvent selected from glycol ethers, dibasic esters, ketone solvents, terpenes, and water.

32. The method of claim 31, wherein the composition comprises a glycol ether selected from monobutyl glycol, tributyl glycol, and tripropylene glycol methyl ether.

33. The method of claim 31, wherein the composition comprises a dibasic ester selected from dialkyl adipate, dialkyl succinate, and dialkyl azelate.

34. The method of claim 31, wherein the composition comprises a ketone solvent selected from acetone and methyl isobutyl ketone.

35. The method of claim 31, wherein the terpene is DL-limonene.

36. (canceled)

37. The method of claim 12, wherein the contaminant is paint, ink, dye, mold, algae, a food particle, or a microorganism.
